(19) United States
(12) Patent Application Publication
(10) Pub. No.: US 2025/0333125 A1
(43) Pub. Date: Oct. 30, 2025

(54) LOCKABLE AND SPRING LOADED PRISMATIC SPINE FOR QUADRUPEDAL LOCOMOTION

(71) Applicant: THE REGENTS OF THE UNIVERSITY OF CALIFORNIA, Oakland, CA (US)

(72) Inventors: Konstantinos Karydis, Riverside, CA (US); Keran Ye, Riverside, CA (US)

(73) Assignee: THE REGENTS OF THE UNIVERSITY OF CALIFORNIA, Oakland, CA (US)

(21) Appl. No.: 19/192,474

(22) Filed: Apr. 29, 2025

Related U.S. Application Data
(60) Provisional application No. 63/639,945, filed on Apr. 29, 2024.

(51) Int. Cl. B62D 57/02

(52) U.S. Cl. CPC B62D 57/02

(57) ABSTRACT

In one aspect, a spine module is provided that suitably comprises: a pair of end plates; a scissor-lift structure mounted to the pair of end plates and comprising a plurality of coupled scissor segments; a rail unit mounted to each of the pair of end plates; and a carriage slidably mounted to each linear rail and including a locking mechanism coupled thereto, the locking mechanism being configured to switch between a locked state in which sliding of the carriage along the linear rail is inhibited and an unlocked state in which sliding of the carriage along the linear rail is permitted.

### CROSS REFERENCE TO RELATED APPLICATIONS

This application claims the benefit of U.S. Provisional Application No. 63/639,945, filed Apr. 29, 2024, which is incorporated by reference in its entirety.

### GOVERNMENT SUPPORT

This invention was made with government support under CMMI 2046270 awarded by the National Science Foundation. The government has certain rights in the invention.

### SUMMARY

Owing to developments in actuators, embedded single board computers and perception units, quadrupedal robots have become more versatile in various agile locomotion tasks including rapid running, aggressive jumping, fast stepping, and other acrobatic maneuvers. A range of existing quadrupedal platforms adopt a single rigid body (SRB) design and extend the overall morphological degree-of-freedoms (DoFs) by employing 3-DoF legs. This approach philosophy can result in modeling representations that can be directly embedded into robot controllers and estimators.

Further extending morphological DoFs may facilitate achievement of more agile locomotion. However, adding more actuated joints within the leg assemblies can be expensive.

Accordingly, embodiments of the present disclosure provide an alternative to additional DoF legs.

For example, compliant prismatic spines suitable for use in robots (e.g., quadrupedal robots) are provided.

As discussed in greater detail below, these robotic spines can be compact and lightweight and include independent controllers and sensors. An automatic spine locking/unlocking mechanism can be implemented by servos triggering for large spinal force. A corresponding robotic platform is further provided that can integrate different prismatic robotic spine interchangeably with minimal effort.

In one aspect, a spine module is provided that suitably comprises: a) a pair of end plates; b) a scissor-lift structure mounted to the pair of end plates and comprising a plurality of coupled scissor segments; c) a rail unit mounted to each of the pair of end plates; d) a carriage slidably mounted to each linear rail and including a locking mechanism coupled thereto, the locking mechanism being configured to switch between a locked state in which sliding of the carriage along the linear rail is inhibited and an unlocked state in which sliding of the carriage along the linear rail is permitted.

In certain preferred a spine modules, a biasing mechanism is also provided and configured to bias the plurality of scissor segments to extend in the longitudinal direction.

In certain preferred a spine modules, an end of the second scissor limb of the scissor segment neighboring the end plate is coupled to the carriage mounted to that end plate.

In certain preferred spine modules; when the locking mechanism is in the unlocked state, the carriage is permitted to slide along the rail to which it is mounted, allowing the first and second scissor limbs of the plurality of scissor segments to pivot about the first, second, and third pivots to cause the scissor-lift structure to extend or retract in the longitudinal direction.

In certain preferred spine modules, when the locking mechanism is in the locked state, the carriage is inhibited from sliding along the rail to which it is mounted, preventing the first and second scissor limbs of the plurality of scissor segments from pivoting about the first, second, and third pivots.

In a further preferred aspect, a spine module is provided that suitably comprises: a) a pair of end plates distanced from one another in a longitudinal direction; b) a scissor-lift structure mounted at respective ends to the pair of end plates and comprising a plurality of scissor segments coupled to one another in series in the longitudinal direction, wherein each scissor segment comprises a first scissor limb and a second scissor limb coupled to one another at a first pivot positioned between respective ends of the first and second scissor limbs, wherein the first and second scissor limbs of neighboring scissor segments are coupled to one another at respective second pivots adjacent to the ends of the first and second scissor limbs; c) a linear rail mounted to each of the pair of end plates, the linear rail extending transverse to the longitudinal direction; d) a carriage slidably mounted to each linear rail and including a locking mechanism coupled thereto, the locking mechanism being configured to switch between a locked state in which sliding of the carriage along the linear rail is inhibited and an unlocked state in which sliding of the carriage along the linear rail is permitted; wherein an end of the first scissor limb of a scissor segment neighboring an end plate is coupled thereto at a third pivot mounted to that end plate; wherein an end of the second scissor limb of the scissor segment neighboring the end plate is coupled to the carriage mounted to that end plate; wherein, when the locking mechanism is in the unlocked state, the carriage is permitted to slide along the rail to which it is mounted, allowing the first and second scissor limbs of the plurality of scissor segments to pivot about the first, second, and third pivots to cause the scissor-lift structure to extend or retract in the longitudinal direction; and wherein, when the locking mechanism is in the locked state, the carriage is inhibited from sliding along the rail to which it is mounted, preventing the first and second scissor limbs of the plurality of scissor segments from to pivoting about the first, second, and third pivots; and e) a biasing mechanism configured to bias the plurality of scissor segments to extend in the longitudinal direction.

In certain preferred spine modules, a spine module suitably further comprises a plurality of collapsible sliders coupled to each of the pair of end plates, wherein the sliders are configured to expand and collapse in the longitudinal direction and wherein the sliders limit the extension of the scissor-lift structure between a predetermined minimum extension length and a predetermined maximum extension length.

In certain preferred spine modules, where a biasing mechanism is present, the biasing mechanism comprises at least one tension spring deployed along the linear rail of each of the pair of end plates, wherein one end of each spring is coupled to the adjacent end plate at a third pivot, and the other end of each spring is attached to the carriage mounted to the adjacent end plate.

In certain preferred spine modules, a spine module suitably further comprises a spine controller including a processor in communication with each locking mechanism and configured to generate a locking command signal that causes each locking mechanism to adopt the locked state upon receipt and an unlocking command signal that causes each locking mechanism to adopt the unlocked state upon receipt.

In certain preferred spine modules, each linear rail extends approximately perpendicular to the longitudinal direction.

In certain preferred spine modules, each locking mechanism comprises a solenoid-servo system.

If present in a spine module, a preferred solenoid-servo system comprises: a solenoid including a pin; a servo in mechanical communication with the pin; wherein the pin is configured to move linearly between an extended position and a retracted position to place the locking mechanism in the locked state and unlocked state, respectively; and a lock panel positioned adjacent to the pin and including a plurality of holes arranged in a line that are dimensioned to receive the pin; wherein receipt of a locking command signal from the controller causes the solenoid to activate and extend the pin into the locked position such that the pin is received within an opposing hole of the lock panel; and wherein receipt of an unlocking command signal from the controller causes the solenoid to deactivate and causes the servo to activate, thereby retracting the pin into the unlocked position such that the pin is removed from an opposing hole of the lock panel.

In further aspects, a robot assembly is provided that comprises a spine module as disclosed herein.

In certain preferred aspects, a robot assembly suitably further comprises a pair of half bodies coupled to opposing sides of the spine module in a movement direction; a first half body including a first pair of legs and a first half body trunk; a second half body including a second pair of legs and a second half body trunk; wherein each of the first and second pair of legs are configured to move with two degrees of freedom; and wherein opposing longitudinal ends of the spine module are coupled to respective ones of the first half body and the second half body.

Other aspects are disclosed infra.

### BRIEF DESCRIPTION OF THE DRAWINGS

These and other features will be more readily understood from the following detailed description taken in conjunction with the accompanying drawings, in which:

FIG. 1 is a schematic illustration of one exemplary embodiment of a quadrupedal robot including a lockable, spring-loaded prismatic spine module;

FIG. 2a is an exploded, schematic illustration of the quadrupedal robot of FIG. 1, including the spine module interposed between two half bodies;

FIG. 2b is an exploded schematic illustration of a half body of the quadrupedal robot of FIG. 2a including two leg modules mounted to a frame;

FIG. 2c is a top-down view of a servo module of a leg module of FIG. 2b;

FIG. 3a is a photograph illustrating the prismatic spine module of FIG. 1;

FIG. 3b is a schematic illustration of a scissor lift structure of the spine module of FIG. 3a;

FIGS. 4a-4b are schematic diagrams illustrating an embodiment of a locking mechanism of the spine module;

FIGS. 4c-4d are photographs of a prototype corresponding to the schematic diagrams of FIGS. 4a-4b;

FIG. 5 is a diagram illustrating a software architecture for operation of the robot of FIG. 1;

FIG. 6a is a plot of force as a function of distance for an embodiment of the spine module of FIG. 3a in a weak spring configuration;

FIG. 6b is a plot of force as a function of distance for an embodiment of the spine module of FIG. 3a in a medium spring configuration;

FIG. 6c is a plot of force as a function of distance for an embodiment of the spine module of FIG. 3a in a strong spring configuration;

FIG. 6d is a plot illustrating distance and force as a function of time for an embodiment of the spine module of FIG. 3a in the strong spring configuration;

FIGS. 7a-7d are photographs illustrating spine module locking/unlocking tests; (a) the spine module is pre-locked and commanded to stay locked; (b) the spine module is pre-unlocked and commanded to stay unlocked; (c) the spine module is pre-unlocked and commanded to be locked at the shortest spine extension length; (d) the spine module is pre-locked and commanded to be unlocked at the shortest spine extension length when the press is detected;

FIGS. 8a-8b are images captured during jumping and landing of the robot of FIG. 1; (a) one jumping and landing trial with the rigid spine module; (b) two consecutive jumping and landing trials with the spring-loaded spine module. The trials of FIG. 8a extend over the middle and bottom row panels and the dashed vertical line denotes the end of the first trial and initiation of the second trial. Critical landing sections are marked in dashed boxes to facilitate a side-by-side comparison of the robot behavior with the rigid (top) and with the compliant (bottom) spine module equipped;

FIG. 9a is a plot of maximum jumping height distribution for robots employing compliant and rigid spine modules; and

FIG. 9b is a plot of maximum jumping velocity for robots employing compliant and rigid spine modules.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Embodiments of a prismatic spine module, quadrupedal robots employing the spine module and corresponding methods of operation are discussed herein. However, embodiments of the spine module can be employed in other robotic systems without limit.

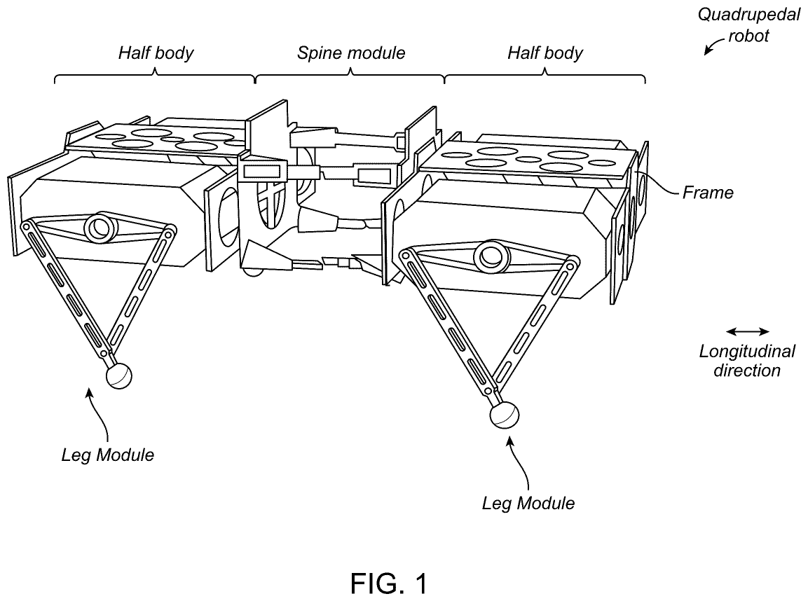

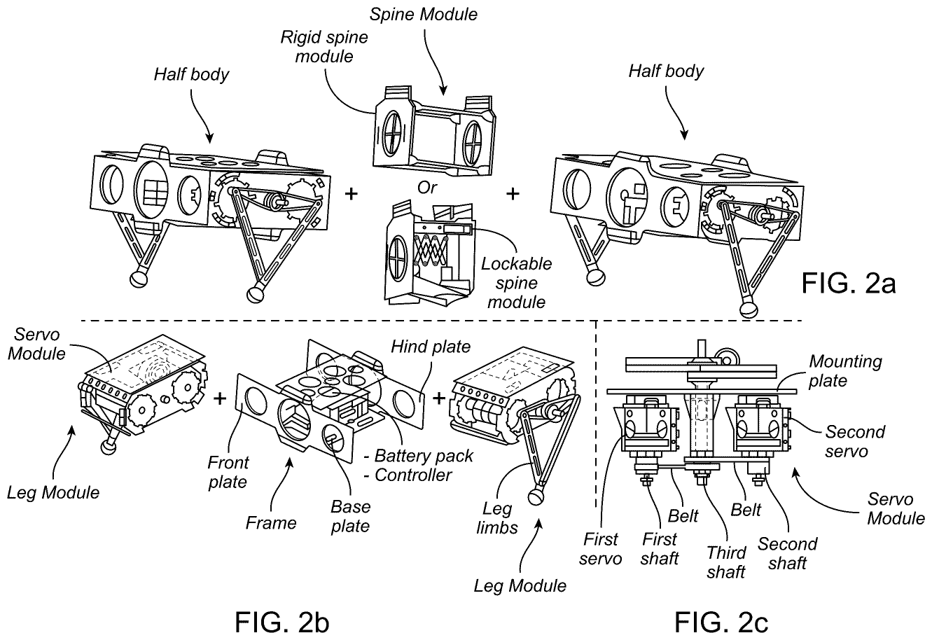

FIGS. 1-2a illustrate one exemplary embodiment of a quadrupedal robot, in assembled and exploded views. As shown, the robot includes a spine module removably coupled to a pair of half bodies. The half bodies are coupled to respective, opposing ends of the spine module in a longitudinal or movement direction of the robot. As discussed in greater detail below, actuators (e.g., servos) and power sources for the robot can be housed within the half bodies. That is, each half body is power independent. Thus, different spine modules (e.g., a rigid spine module, an embodiment of the lockable, spring loaded spine module discussed herein, etc.) can be easily interchanged, depending upon the desired functionality of the robot.

In an embodiment, the robot can include a single controller mounted within a selected one of the half bodies (e.g., the fore half body) for control of the servos of both half bodies. In this configuration, signal communication is present between the servos of the two bodies and the single controller (e.g., via wired signal lines, such as controller area network (CAN-BUS) lines), and movement of the two half bodies can be coordinated with one another. half

In an alternative embodiment, the robot can include two controllers, each mounted within one of the half bodies and controlling only the servos of the half body in which it is mounted. In this configuration, signal communication between the two bodies can be minimal or absent, and movement of the two half bodies can be independent from one another. half

FIG. 2b is an exploded schematic illustration of a half body of the quadrupedal robot of FIG. 2a. As shown, the half body includes a frame and a pair of leg modules. The frame includes a plurality of frame plates, including a base plate and front and hind plates. The frame plates can be approximately planar and adopt a shape suitable for mounting components of the half body and the spine module thereto (e.g., square, rectangular, circular, etc.) as well as for coupling the base plate and front and hind plates to each other. The front and hind plates can be mounted to respective ends of the base plate in the longitudinal direction to define a cavity therebetween having a predetermined size and shape (e.g., a rectangular cavity). The cavity can be dimensioned to receive as electrical components such as one or more batteries, controllers, etc. of the half body.

The materials forming the frame can be selected to provide good tradeoffs between weight, rigidity, and cost. For example, the frame plates can be formed from wood (e.g., birch wood) and limbed with plastic connectors.

One or more through holes of various sizes can be formed in the frame plates for fixation devices (e.g., screws, bolts, etc.), cable routing, and/or other physical properties (e.g., weight, stiffness, etc.) For example, the spine module can be coupled to each of the half bodies at respective, opposing frame plates of the half bodies in the longitudinal direction (e.g., the hind plate of a front half body and the front plate of a rear half body).

A pair of leg modules can be further coupled to the frame of each half body. As shown in FIGS. 2b-2c, each leg module can include a leg module and a servo module. The leg module can include one or more leg limbs. For example, each leg module can include a pair of leg limbs that are approximately linear and joined to one another in an inverted V shape. The vertex of the V shape can be configured for contact with the ground. Thus, a contact member configured to facilitate movement of the robot can be further coupled to the vertex of the V shape. The contact member can adopt a generally curved shape (e.g., spherical, ovoid, etc.) and be formed from a material having relatively predetermined mechanical properties (e.g., compliance, coefficient of friction, wear resistance, etc.) In certain embodiments, the contact member can be formed from an elastomer or elastomer containing composite.

The servo module can include a pair of servos and a plurality of approximately co-axial shafts arranged in a hip assembly limbed to the leg limbs. The hip assembly can adopt a flat-symmetrical arrangement to balance the mass about the hip center. As shown, a first servo can be coupled to a first shaft and a second servo can be coupled to a second shaft. The first and second shafts can be further coupled to respective ends of the leg members opposite the vertex. A third shaft can be positioned between the first and second shafts. Pretensioned timing belts can be provided between the first and third shafts and between the second and third shafts to transmit motion between the leg limbs. The timing belts can further serve as a failure buffer to protect the servos from extreme impact upon the leg members during agile maneuvers. The servos of each leg member can be in electrical communication with the controller and power supply of the half body to which it belongs for control of actuation of the leg members.

### Spine Module

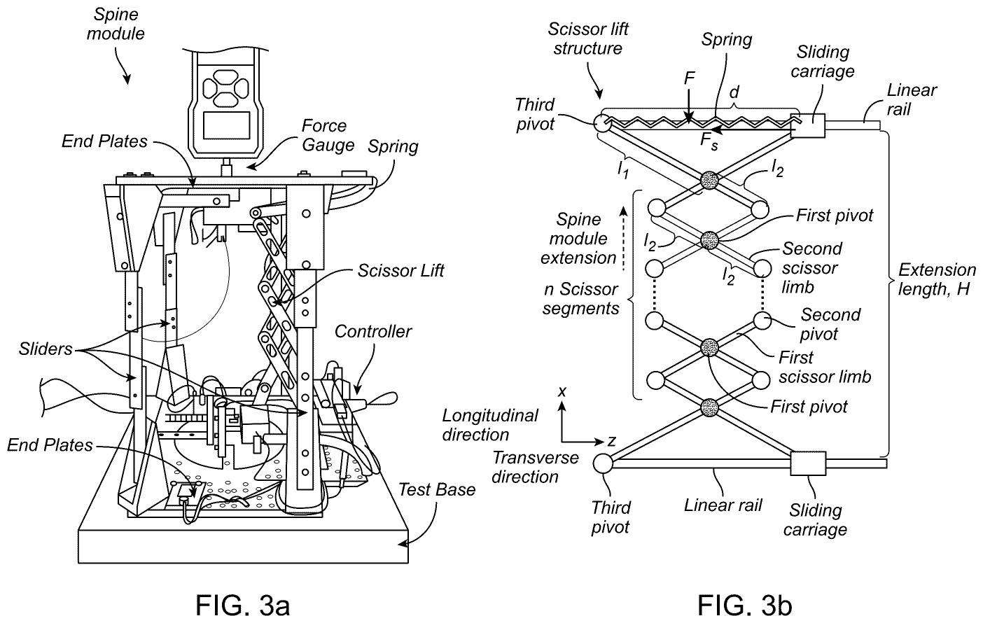

FIG. 3a is a photograph illustrating an embodiment of the prismatic spine module of FIG. 1. As shown, the spine module includes a scissor lift structure and a plurality of collapsible sliders mounted to opposing end plates. The scissor lift structure, and therefore the spine module, is configured to expand and contract in the longitudinal direction within a range of travel extending between a minimum extension length Hₘᵢₙ and a maximum extension length Hₘₐₓ defined by the sliders.

As further discussed below, the spine module is biased to extend in the longitudinal direction, providing compliance. Passively compliant spine actuation is advantageous because the compliance can produce high-density energy storage in lightweight components and high-frequency response through mechanical feedback. The bias can be achieved using one or more springs (e.g., tension springs). For example, in certain embodiments, the spine module can include a plurality of springs having different spring constants, as discussed in detail below.

The spine module is also configured to reversibly lock at a selected extension length H_{lock} between Hₘᵢₙ and Hₘₐₓ. The locking/unlocking functionality of the spine module can enable different locomotion modes in variously circumstances. The spine module can be locked to act as a single rigid body when the robot requires accurate motion with low speed and unlocked to be passively compliant for less precise but more agile locomotion.

FIG. 3b is a schematic illustration of the scissor lift structure in greater detail. As shown, the scissor lift structure is mounted at respective ends to the pair of end plates and includes a plurality of scissor segments (e.g., n scissor segments) coupled to one another in series in the longitudinal direction. Each scissor segment includes a first scissor limb and a second scissor limb coupled to one another at a first pivot between respective ends of the first and second scissor limbs.

The first and second scissor limbs of neighboring scissor segments can be coupled to one another at second pivots located at, or adjacent to, ends of the first and second scissor limbs. The first pivot of the neighboring scissor segments can be positioned at a location approximately equidistant from the opposing ends of the first and second scissor limbs. That is, a distance l₂ between the respective ends of the first and second scissor limbs and the first pivot of neighboring scissor segments can be approximately the same.

A linear rail can be further mounted to each of the pair of end plates of the spine module, extending in a direction transverse to the longitudinal direction. As discussed herein, the longitudinal direction can be an x-direction and the transverse direction (actuation direction) can be a z-direction that extends approximately perpendicular to the longitudinal direction. A sliding carriage is further slidably mounted to each of the rails.

A scissor segment positioned between an end plate and another neighboring scissor segment can be coupled at one end to the neighboring scissor segment as discussed above and to the end plate at the other end. For example, one end of the first scissor limb of this scissor segment is coupled to the second scissor limb of a neighboring scissor segment at a second pivot, and the other end of the first scissor limb of this scissor segment is coupled to the end plate at a third pivot. One end of the second scissor limb of this scissor segment is coupled to the first scissor limb of the neighboring scissor segment at another second pivot, and the other end of the second scissor limb of this scissor segment is coupled to the end plate at the carriage.

The first pivot of a scissor segment positioned between an end plate and another neighboring scissor segment can be positioned at a location closer to the neighboring scissor segment than the end plate. For example, the first pivot can be positioned at the distance l₂ from respective ends of the first and second scissor limbs adjacent to the neighboring scissor segment and a distance l₁ from the opposing end of the first and second scissor limbs adjacent to the end plate, with l₁ being greater than l₂.

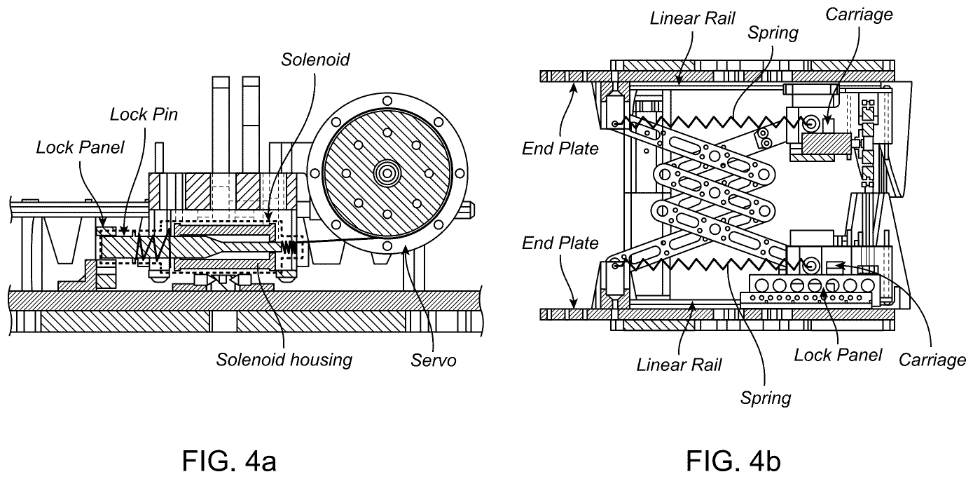

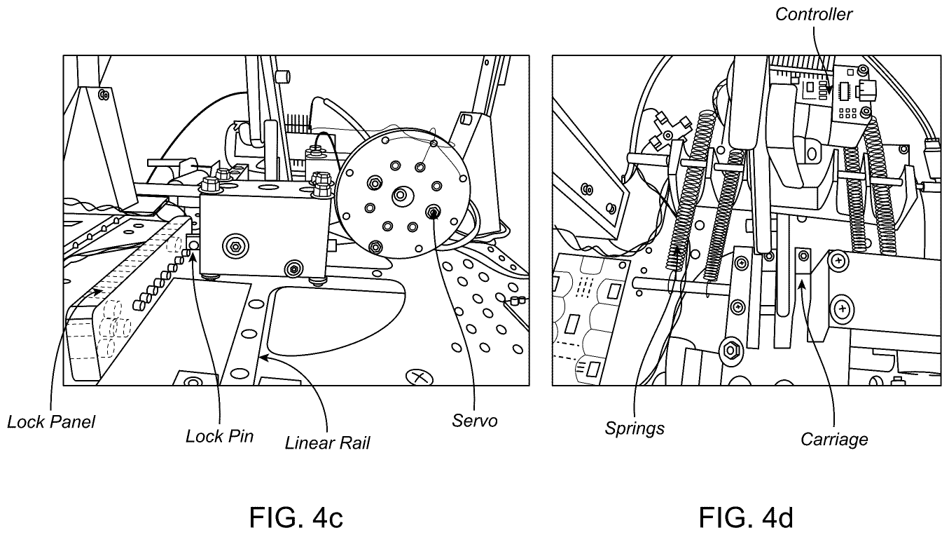

As further illustrated in FIG. 4, the spine module can also include one or more springs configured to bias the spine module (e.g., to extend the spine module in the longitudinal direction). The spring(s) can be deployed along the linear rail. For example, one end of the spring(s) can be mounted to the spine end plate and the other end can be connected to a mounting rod installed on the carriage.

### Spine Model

A model for the spine module is discussed in detail below with further reference to FIG. 3b.

The spine module (e.g., the scissor lift structure) is designed to transform motion in the longitudinal or spine extension direction (x-direction) into the z-axis (actuation direction). A larger spine length change can be achieved with a shorter actuation distance through the n scissor segments. A non-even pattern can be applied for the scissor lift structure to give more freedom to the geometric adjustment over the spine extension and the actuation span.

The spine model assumes that all scissor segments and end plates are massless and all joints are frictionless. The scissor segments attached to the end plates include scissor limbs having total length l₁+l₂ and the remaining scissor segments attached only to neighboring scissor segments include scissor limbs having total length 2l₂. This leads to Equation 1 for the spine extension length H:

$$H = {n}^{′} \sqrt{4 {l}_{1}^{2} - {d}^{2}} , {n}^{′} = 1 + ( n = 1 ) \frac{{l}_{2}}{{l}_{1}} \qquad ( 1 )$$

where d is the actuation span length, n is the number of scissor segments, and n′ is a transformed number of scissor segments for use in force analysis.

Due to the massless assumption above, inertia can be ignored. Thus, a relationship for force F of the spring-loaded spine module as a function of spine extension length H is given by Equation 2:

$$F = \frac{2}{{n}^{′}} ( H - {H}_{o} \sqrt{\frac{4 {l}_{1}^{2} {n}^{′2} / {H}_{o}^{2} - 1}{4 {l}_{1}^{2} {n}^{′2} / {H}^{2} - 1}} ) {K}_{s} , H \leq {H}_{o} \qquad ( 2 )$$

where Kₛ is the expansion spring constant and Hₒ is the equilibrium spine extension length where the spine module is at rest length (neither compressed nor extended). It may be understood that the equilibrium spine extension length Hₒ can be beyond the reach of the spine extension length H if the spring is pre-tensioned at the shortest actuation span.

The force F can be partitioned into two components, a linear component Fₗᵢₙ and a non-linear component, Fₙₒₙₗᵢₙ, as given by Equation 3:

$$F = {F}_{lin} + {F}_{nonlin} \qquad ( 3 )$$

Fₗᵢₙ is given by Equation 4 and is linear in regard to spine extension length H:

$${F}_{lin} = \frac{2}{{n}^{′}} {HK}_{s} \qquad ( 4 )$$

and Fₙₒₙₗᵢₙ is given by Equation 5:

$${F}_{nonlin} = - \frac{2}{{n}^{′}} {H}_{o} \sqrt{\frac{4 {l}_{1}^{2} {n}^{′2} / {H}_{o}^{2} - 1}{4 {l}_{1}^{2} {n}^{′2} / {H}^{2} - 1}} {K}_{s} \qquad ( 5 )$$

Fₙₒₙₗᵢₙ diminishes with the spine extension length H near 0 and

$$reaches - \frac{2}{{n}^{′}} {H}_{o}$$

### as H→Hₒ.

The interpretation of Equations 1 and 2 suggests non-linear geometric and force relationships, while the force curve can be approximately linearly when the extension spine length H is short (e.g., the spine module is in a compressed state). Conversely, the force curve has one peak before the spine extension length H reaches the equilibrium spine extension length Hₒ and its value Hₚₑₐₖ can be obtained by numerically solving a 6^{th}-degree polynomial equation. Thus, it can be desirable to design the maximum spine extension length Hₘₐₓ to be near Hₚₑₐₖ because F will decrease rapidly towards 0 after the spine module extends over the peak spine extension length Hₚₑₐₖ.

It can be further observed that the above-discussed spine model functions similarly to a degressive spring when H<Hₚₑₐₖ. That is, the spine module becomes easier to compress as it is further compressed. Such a configuration makes it easier to restore elastic energy when the sine is forced back to its shortest length (Hₘᵢₙ) by any external force. Thus, in terms of utilizing elastic energy by extending the spine extension length H, this characteristic of the spine module helps to exert more spinal force to propel the robot body instead of the force degression characterized by a normal compression spring model.

### Locking Mechanism

The locking mechanism facilitates the locking/unlocking functionality of the spine module. The locking mechanism can be mounted to each carriage and configured to switch between a locked state, in which sliding of the carriage along the linear rail is inhibited, and an unlocked state in which sliding of the carriage along the linear rail is permitted.

The locking mechanism is illustrated in greater detail in FIGS. 4a-4b. As shown, the locking mechanism is based upon a solenoid-servo system including a solenoid (outlined by dashed lines), a servo, and a lock panel. The solenoid-servo system is mounted on a carriage, together forming a prismatic joint sliding along the linear rail to which it is mounted.

The solenoid functions as a solenoid lock and includes a housing, a wire coil, a pin, and a spring. The pin is configured to slide linearly with respect to the housing between an extended position and a retracted position. In the extended position, the pin protrudes from the housing by a first predetermined length. In the retracted position, the pin protrudes from the housing by a second predetermined length, less than the first predetermined length.

The wire coil is in communication with an electrical current source (e.g., a DC current source) and generates a magnetic field when current flows through the coil (solenoid activated). The magnetic field causes the pin to move outward from the housing and adopt the extended position. The spring opposes extension of the pin and, when the flow of current through the coil is stopped (solenoid deactivated), the spring assists retraction of the pin back towards the housing to adopt the retracted position. The servo is connected to the pin to further assist with retraction of the pin to adopt the retracted position. The lock panel is mounted to the adjacent end plate and includes a plurality of holes arranged in a line that are dimensioned to receive the pin.

The spine module further includes a spine controller including a processor in communication with each locking mechanism. The spine controller is configured to generate a locking command signal that causes each locking mechanism to adopt the locked state upon receipt and an unlocking command signal that causes each locking mechanism to adopt the unlocked state upon receipt.

When locking of the spine module is needed, the spine controller transmits the locking command signal to the solenoid to place the locking mechanism in the locked state. Upon receipt, the locking command signal causes the solenoid to energize and push the pin forward, into the extended position for insertion into a locking hole, placing the locking mechanism in the locked state. When the locking mechanism is in the locked state, the first and second scissor segments of the plurality of scissor segments are inhibited from to pivoting about the first, second, and third pivots. Thus, placing the locking mechanism in the locked state further places the spine module in the locked state, holding the extension length of the spine module at H_{lock}.

When unlocking of the spine module is needed, the spine module transmits the unlocking command signal to the solenoid and the servo to place the locking mechanism in the unlocked state. Upon receipt of the unlocking command, the solenoid deactivates and the servo activates. For example, flow of current to the solenoid stops and the servo actuates to retract the lock pin from the locking hole in which it is inserted (e.g., using a string wheel attached to the pin), placing the locking mechanism in the unlocked state. The servo spring further assists with the retraction of the pin. When the locking mechanism is in the unlocked state, the spine module is also placed in the unlocked state. So configured, the first and second scissor segments of the plurality of scissor segments are permitted to pivot about the first, second, and third pivots to cause the scissor-lift structure to extend or retract in the longitudinal direction, allowing the extension length H of the spine module to move between Hₘᵢₙ and Hₘₐₓ.

It has been identified that considerable spine elastic force can be necessary, along with leg actuation thrust, to thrust the robot forward (e.g., in the longitudinal direction) during agile maneuvers. Such a condition can expose the lock pin to a significant amount of friction when it is pulled by the servo from the locked position to the unlocked position. This, in turn, can increase the likelihood of damage to the locking mechanism (e.g., the servo).

Accordingly, a perception-based process for locking and unlocking the spine module is provided based on the following logic.
When the lock pin is in the locked position, with the spine module adopting the spine extension length H_{lock}, the locking mechanism can only be unlocked when (1) the unlocking command is received from the controller and (2) an external press is applied to the locking pin releasing the lock pin from close contact with the locking hole. The external press can be a force applied to the spine module (e.g., by the operator using their hands) in the longitudinal (x) direction that has a magnitude is greater than or equal to a predetermined force. This predetermined force can be selected such that it compresses the spine by a selected amount. Subsequently, the servo can operate to pull out the pin from the locking hole.
The external press is captured by a modified cumulative sum control chart (CUSUM) edge detection algorithm at the spine extension length H_{lock}. The spine extension length H_{lock} is observed through the distance sensors mounted at the spine end plates. When the external press is applied to the spine end plates with a force greater than or equal to the predetermined force, the spine is slightly compressed and H_{lock} is reduced. This results in a signal falling edge of H_{lock} observation. The CUSUM algorithm is used to detect this signal falling edge, which indicates that the spine module is being properly pressed.
When the lock pin is unlocked, any locking command can allow the servo to release the spring-loaded lock pin into the nearest locking hole to hold the extension length of the spine module at H_{lock}.

As such, the locking mechanism can act similarly to a MOSFET transistor (which can control a much current with minimum current input) to release and retain significant elastic energy with small locking/unlocking actuation power.

### Examples

A prototype robot in accordance with embodiments of the disclosure is discussed in detail below.

### Actuation

The servos selected for the prototype robot are brushless direct current (DC) motor (T-Motor MN5212 kv 340) with a planetary gear set (0.5 module, 6:1 reduction). The controller selected for the example robot is a brushless DC (BLDC) motor control board (MJBOTS Moteus r4.5). The servo module is fitted into a 3D printed (Markforged Mark 2 and Onyx material) plastic enclosure.

As illustrated in Table I, the actuator can achieve position-velocity-torque control with high torque density.

TABLE I
Summary of Example Robot Properties

| Property | Symbol | Value | |
|---|---|---|---|
| Half body Mass | m_{half} | 4.6 | kg |
| Battery Mass | m_{batt} | 0.7 | kg |
| Upper Limb Mass | m_{ulimb} | 45 | g |
| Lower Limb Mass | _{mllimb} | 55 | g |
| Upper Limb Length | l_{ulimb} | 0.1 | m |
| Lower Limb Length | l_{llimb} | 0.2 | m |
| Rigid Spine Mass | mᵣₛₚᵢₙₑ | 0.6 | kg |
| Rigid Spine Length | lᵣₛₚᵢₙₑ | 0.23 | m |
| Compliant Spine Mass | m_{cspine} | 1.2 | kg |
| Compliant Spine Length | l_{cspine} | 0.12-0.24 | m |
| Motor Mass | mₘₒₜₒᵣ | 0.21 | kg |
| Servo Mass | mₛₑᵣᵥₒ | 0.44 | kg |
| Motor Peak Torque | τₘₒₜₒᵣ | 0.92 | Nm |
| Shaft Peak Torque | τ_{shaft} | 9.2 | Nm |

| | | |
|---|---|---|
| Overall Reduction | r | 10:1 |
| Gear Reduction | r_{gear} | 6:1 |
| Belt Reduction | r_{belt} | 67:1 |

### Software

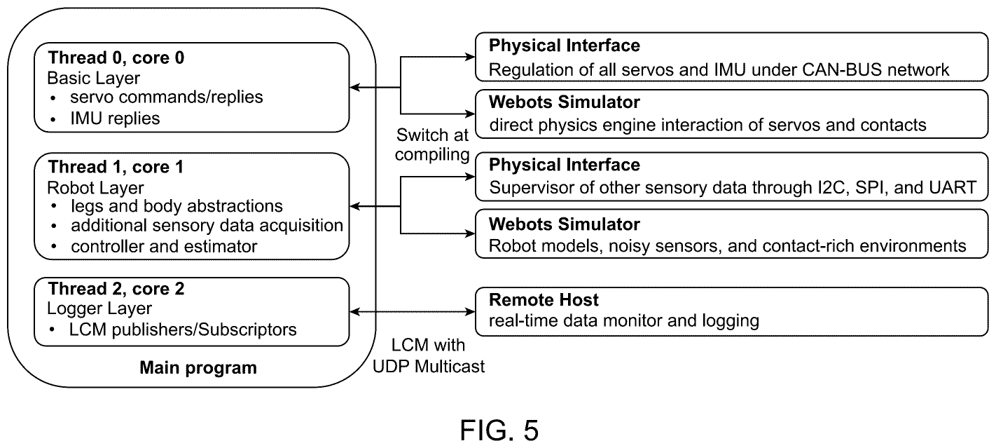

An architecture for the robot executed by the controller mounted within the half body frame is illustrated in FIG. 5. The controller for the half bodies includes a main computer (Raspberry Pi® 4B+), a servo communication board (MJBOTS Pi3hat e4.4), and an LED cooling fan. The main computer runs a Preempt-RT patched Linux kernel to enable a soft real-time execution of the whole controller program, and works with the servo communication board to regulate all servos through four CAN-FD BUS lines, with each line responsible for one leg module. In this prototype robot, a single controller was employed on the fore half body. However, optionally, a second controller could be employed in the rear half body, allowing distributing and collaborating motion control. A minimal finite state machine (FSM) is used to allow for online scheduling of different locomotion tasks.

In this prototype robot, a single controller was employed within the fore half body. However, optionally, a second controller could be employed in the rear half body, allowing distributing and collaborating motion control. A minimal finite state machine (FSM) is used to allow for online scheduling of different locomotion tasks.

The controller of the spine module includes a single board computer (Raspberry Pi® Zero Wireless) and a servo control hat (SparkFun Servo pHAT) that connects to a pair of distance sensors (SparkFun Distance Sensor VL53L4CD) for edge detection. The spine length is estimated by an average of the pair of the two distance sensor measurements and falls back to one measurement if the other fails.

As illustrated in FIG. 5, a multi-threaded main program executes on the main computer for all necessary calculations and interacts with the physical interface for all information exchange between the servos (through the servo communication board) and other units (such as the controller of the compliant spine module). Simulation is synchronized with the main program in parallel and is carried out in Webots with the direct use of the provided physical engine for the sake of more realistic legged behaviors in contact-rich contexts.

Two different CPU architectures are used for Webots simulation (on a laptop with ×86-64 CPUs) and real robot (Raspberry Pi running on ARM CPUs). To alleviate the coding adaptation workload, the simulation interface is as analogous to the physical interface as possible, and the switching between these two interfaces can be done at compiling time with a single flag set. The communication between the controller(s) of the half bodies and the controller of the spine module is distributed as two custom nodes on the Lightweight Communications and Marshalling (LCM) network. So configured, any other spine module can be limbed to the main controller node with its own LCM node following certain message principles.

### Prototype Spine Module

As noted above, FIG. 3a is a photograph illustrating a prototype of the spine module. The whole spine module weights 1.2 kg, which is heavier than the 0.6 kg rigid spine (Table I), yet it can exert up to 80 N spine force from the springs. The main structure includes two end panels limbed by four miniature sliders that confine the spine length range. Each end panel is laser cut (VLS 3.60) from birch wood board and contains the miniature linear rail with the unlocking mechanism powered by a small SG90S servo. The scissor lift structure is spring loaded and bolted along the linear rails on the two end panels.

Table II presents design parameters of the scissor lift structure, with specific values of slider limitation.

TABLE II
Prototype Spine Design Parameters

| Parameter | Symbol | Value |
|---|---|---|
| Number of scissor segments | n | 3 |
| Scissor lift limb length | l₁, l₂ | 0.03 m, 0.06 m |
| Spine Extending Length | H | 0.08-0.20 m |
| Spring Extending Length | d | 0.06-0.10 m |

Actual spine length l_{cspine} (Table I) is H plus an installment offset δH = 0.04 m.
Hₚₑₐₖ = 0.19 m.

### Spine Characterization Test

FIG. 3a further illustrates a spine module testbed used to perform spine module characterization experiments. The prototype spine module stands upright with the bottom end plate fixed to a flat, wooden table base. A force gauge is used to apply force at the center of the top end plate while recording force measurements.

Spine characterization is performed using two types of linear extension springs. Both have the same rest length, dₒ=0.096 m, but have different spring constants (soft: K_{s,soft}=224 N/m; stiff: K_{s,stiff}=364 N/m). Combinations of these springs result in three different compliant configurations, weak (four soft springs), medium (four stiff springs), and strong (four soft springs and four stiff springs). For each configuration, 20 trials are performed with spine extension-compression routines. Data is collected through the spine module controller and the force gauge.

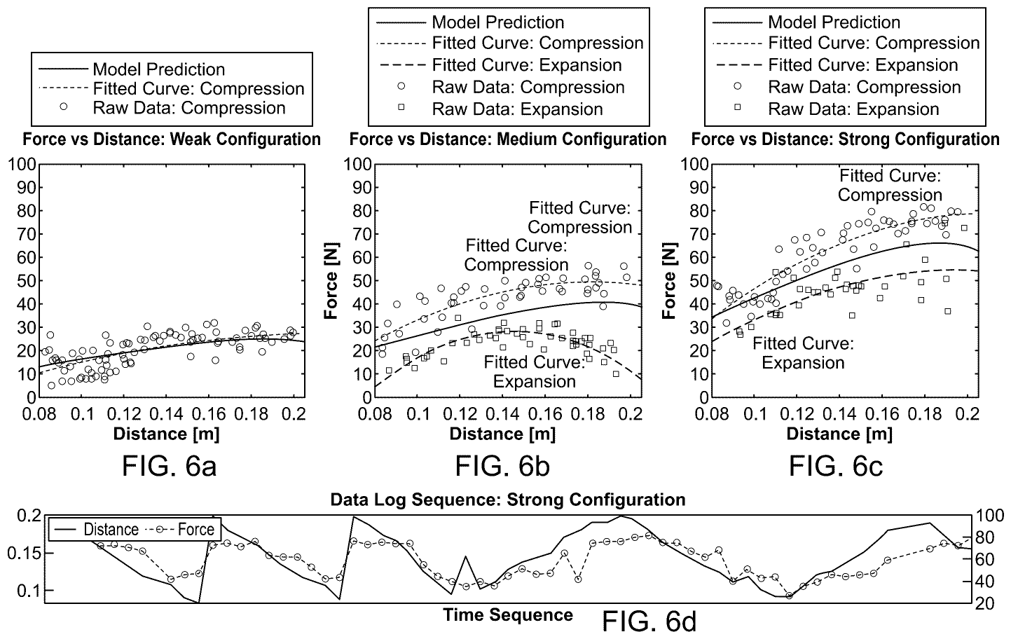

Results of the spine module characterization experiments are illustrated in FIGS. 6a-6d. FIGS. 6a-6c are plots of force as a function of distance for the prototype spine module in the weak, medium, and strong spring configurations, respectively. The model prediction curve (solid line), data from experiments (circle for spine compression, square for spine extension), and fitted curves (dashed lines for spine compression and for spine extension). Before visualization, the raw data were down sampled and filtered to remove outliers. The raw data are fitted with order-2 polynomial curves.

Results suggest that the simplified model offers a satisfactory prediction for the force-length relation. The force-length curve during spine compression (or extension) is with an observable positive (or negative) offset from the predicted curve. This is attributed primarily due to the sliders' friction acting along (or against) the spinal force. It is further observed that the strong spring configuration outperforms the weak and medium spring configurations, with spinal force peak close to the longest length.

FIG. 6d is a plot of distance and force as a function of time for the prototype spine module in the strong spring configuration. This plot visualizes the degressive spring-like behavior of the prototype spine module, with the spinal force and length positively correlated.

### Spine Locking/Unlocking Verification

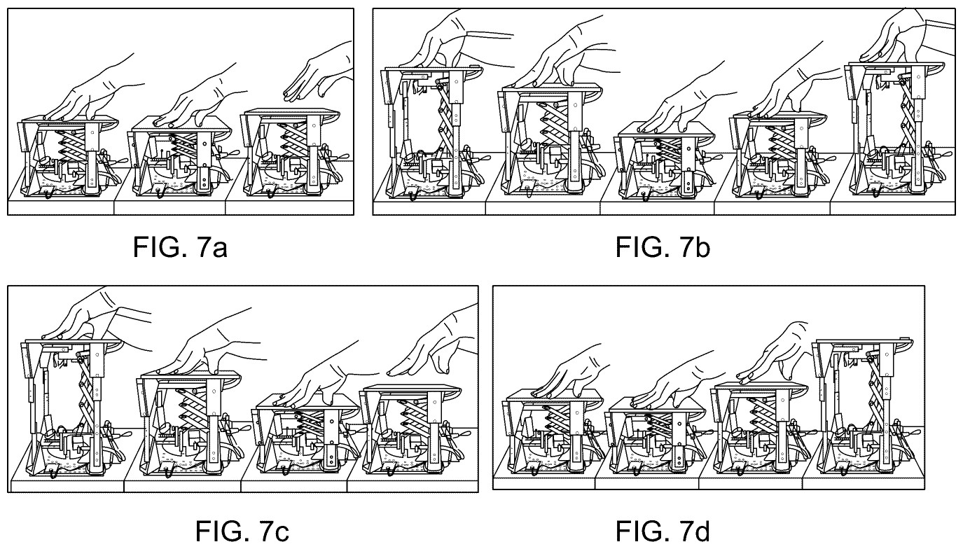

A verification experiment of the locking mechanism was conducted using the same test bed as the spine module characterization test. FIGS. 7a-7d are photographs illustrating four different situations the locking mechanism can encounter during locomotion.
When the spine module is currently locked and the robot commands the spine module to stay locked (FIG. 7a).
When the spine module is currently unlocked and the robot commands the spine module to stay unlocked so that the robot is free to move (FIG. 7b).
When the spine module is currently unlocked and the robot commands the spine module to lock when it is pressed to its shortest length (FIG. 7c).
When the spine module is currently locked and the robot commands the spine module to unlock when it is pressed at its shortest length (FIG. 7d).

As shown, the locking mechanism produced the desired actions for each situation. In addition, the spine module can respond to fat spine motion and large spinal force in real-time.

### Robot Vertical Jumping and Landing Test

To evaluate the efficacy of the spine module in high-impact, aggressive quadruped locomotion, robot performance during vertical jumping and landing. Based upon the above-discussed results of spine characterization testing, a strong compliance configuration was selected for the spine module. Comparisons are made against a rigid spine module. Each of the strong compliance spine module and rigid spine module can be equipped in an interchangeable manner to the robot.

20 trials of vertical jumping and landing are performed for each spine module with a similar battery level. All servos were limited to 70% of their peak torque. The robot is connected to a local Wi-Fi network shared with a remote host for collection of proprioceptive data from servos and onboard inertial measurement units (IMUs) through LCM. The remote host further saves robot posture information provided by a VICON motion capture system. All motions of the robot were concurrently recorded with a high-speed action camera for post-analysis.

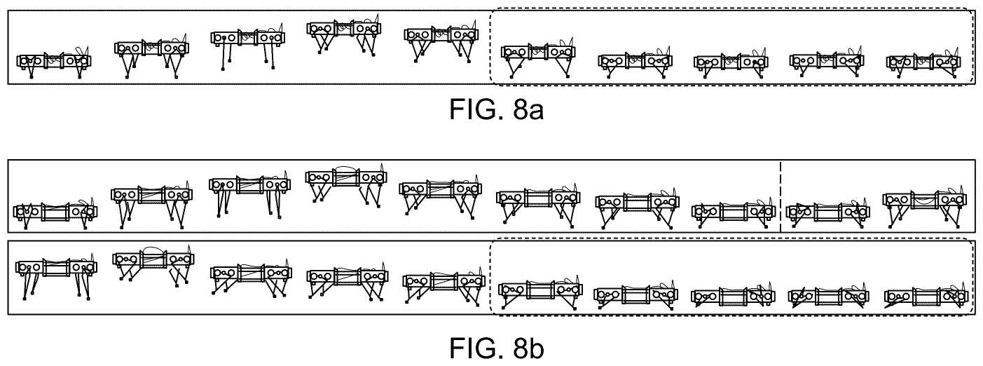

Investigation was performed to determine whether or not spinal compliance can affect the landing procedure, particularly when the robot is not landing properly with the legs because of body tilting and varied contact times among feet upon impact. FIG. 8a presents images of one jumping and landing trial with the rigid spine module. FIG. 8b presents two consecutive jumping and landing trials with the spring-loaded spine module. The trials of FIG. 8b extend over the middle and bottom row panels and the dashed vertical line denotes the end of the first trial and initiation of the second trial.

FIG. 8a shows one of the successful jumping attempts with the rigid spine module. Despite solid jumping performance overall, the timing belt occasionally experienced some slippage when the landing posture was not ideal and the legs did not properly compensate for the large ground reaction forces that could cause the robot's body to bounce, as shown in the dashed box region marked in FIG. 8a.

It can be observed that the first jump of FIG. 8b results in mild landing conditions, similar to FIG. 8a, yet without any body bouncing. The second jump of FIG. 8b exposes more challenging landing situations, which can be overcome owing to the spring-loaded spine module. That is, the compliant spine module compresses to some extent to mitigate the impact from the legs when an unfavored landing posture occurs. FIG. 8b captures this effect in the dashed box region. This shows that the spring-loaded spine module can absorb impact energy that is 1) partially stored as the spine module's elastic energy and 2) dissipated for the rest through the front feet slipping, similar to a cat stretching under the degressive spring property of the compliant spine module.

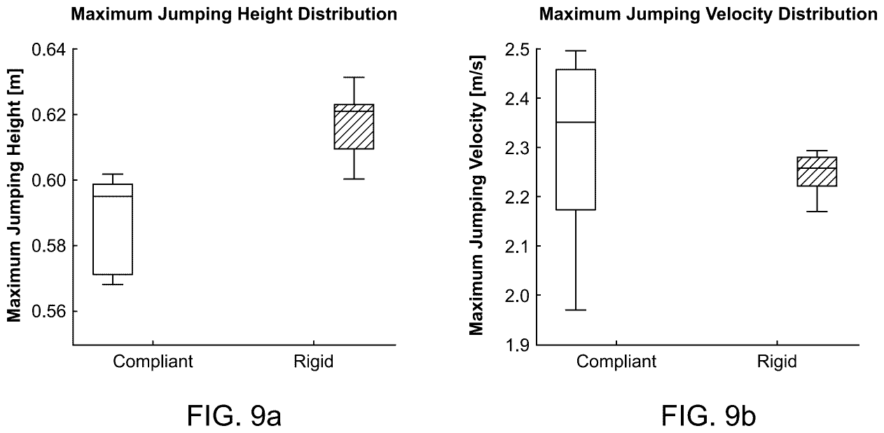

FIGS. 9a-9b are plots of maximum height distribution and maximum jumping velocity for robots employing compliant and rigid spine modules. The results suggest that the two spine modules share similar jumping performances, on average. The robot with the compliant spine module experienced a little smaller jumping height due to the extra weight of the spine compared to the rigid one, yet it was capable of producing larger peak velocities. Notwithstanding the fact that the rigid spine module delivers more consistent jumping behaviors, the compliant spine module enables more aggressive motion in exchange of precision, a feature which can serve well in some agile locomotion tasks.

Exemplary technical effects of the methods, systems, and devices described herein include, by way of non-limiting example, a spring-loaded lockable spine module together with a new quadrupedal robot platform. Advantageous spinal properties, similar to a degressive spring, are observed, validating the use of the locking mechanism for the spine module. Physical experiments with the robot demonstrate similar jumping performance between rigid and compliant spine modules, with the compliant spine module exhibiting better performance in more challenging landing situations.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structure disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified but a range including the precise value specified and values greater than and less than the precise value specified. For example, the range can include values that are within ±10%, ±9%, ±8%, ±7%, ±6%, ±5%, ±4%, ±3%, ±2%, ±1%, ±0.5%, ±0.1%, etc. of the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A spine module comprising:
a pair of end plates;
a scissor-lift structure mounted to the pair of end plates and comprising a plurality of coupled scissor segments;
a rail unit mounted to each of the pair of end plates; and
a carriage slidably mounted to each linear rail and including a locking mechanism coupled thereto, the locking mechanism being configured to switch between a locked state in which sliding of the carriage along the linear rail is inhibited and an unlocked state in which sliding of the carriage along the linear rail is permitted.

2. The spine module of claim 1 further comprising:
a biasing mechanism configured to bias the plurality of coupled scissor segments to extend in the longitudinal direction.

3. The spine module of claim 1, further comprising:
a plurality of collapsible sliders coupled to each of the pair of end plates, wherein the sliders are configured to expand and collapse in the longitudinal direction and wherein the sliders limit the extension of the scissor-lift structure between a predetermined minimum extension length and a predetermined maximum extension length.

4. The spine module of claim 1, wherein the biasing mechanism comprises at least one tension spring deployed along the linear rail of each of the pair of end plates, wherein one end of each spring is coupled to the adjacent end plate at a third pivot, and an other end of each spring is attached to the carriage mounted to the adjacent end plate.

5. The spine module of claim 1, further comprising:
a spine controller including a processor in communication with each locking mechanism and configured to generate a locking command signal that causes each locking mechanism to adopt the locked state upon receipt and an unlocking command signal that causes each locking mechanism to adopt the unlocked state upon receipt.

6. The spine module of claim 5, wherein each linear rail extends approximately perpendicular to the longitudinal direction.

7. The spine module of claim 5, wherein each locking mechanism comprises a solenoid-servo system.

8. The spine module of claim 7, wherein the solenoid-servo system comprises:
a solenoid including a pin;
a servo in mechanical communication with the pin;
wherein the pin is configured to move linearly between an extended position and a retracted position to place the locking mechanism in the locked state and unlocked state, respectively;
a lock panel positioned adjacent to the pin and including a plurality of holes arranged in a line that are dimensioned to receive the pin;
wherein receipt of a locking command signal from the controller causes the solenoid to activate and extend the pin into the locked position such that the pin is received within an opposing hole of the lock panel; and
wherein receipt of an unlocking command signal from the controller causes the solenoid to deactivate and causes the servo to activate, thereby retracting the pin into the unlocked position such that the pin is removed from an opposing hole of the lock panel.

9. A spine module, comprising:
a pair of end plates distanced from one another in a longitudinal direction;
a scissor-lift structure mounted at respective ends to the pair of end plates and comprising a plurality of scissor segments coupled to one another in series in the longitudinal direction, wherein each scissor segment comprises a first scissor limb and a second scissor limb coupled to one another at a first pivot positioned between respective ends of the first and second scissor limbs, wherein the first and second scissor limbs of neighboring scissor segments are coupled to one another at respective second pivots adjacent to the ends of the first and second scissor limbs;
a linear rail mounted to each of the pair of end plates, the linear rail extending transverse to the longitudinal direction;
a carriage slidably mounted to each linear rail and including a locking mechanism coupled thereto, the locking mechanism being configured to switch between a locked state in which sliding of the carriage along the linear rail is inhibited and an unlocked state in which sliding of the carriage along the linear rail is permitted;
wherein an end of the first scissor limb of a scissor segment neighboring an end plate is coupled thereto at a third pivot mounted to that end plate;
wherein an end of the second scissor limb of the scissor segment neighboring the end plate is coupled to the carriage mounted to that end plate;
wherein, when the locking mechanism is in the unlocked state, the carriage is permitted to slide along the rail to which it is mounted, allowing the first and second scissor limbs of the plurality of scissor segments to pivot about the first, second, and third pivots to cause the scissor-lift structure to extend or retract in the longitudinal direction; and
wherein, when the locking mechanism is in the locked state, the carriage is inhibited from sliding along the rail to which it is mounted, preventing the first and second scissor limbs of the plurality of scissor segments from pivoting about the first, second, and third pivots; and
a biasing mechanism configured to bias the plurality of scissor segments to extend in the longitudinal direction.

10. The spine module of claim 9, further comprising:
a plurality of collapsible sliders coupled to each of the pair of end plates, wherein the sliders are configured to expand and collapse in the longitudinal direction and wherein the sliders limit the extension of the scissor-lift structure between a predetermined minimum extension length and a predetermined maximum extension length.

11. The spine module of claim 9, wherein the biasing mechanism comprises at least one tension spring deployed along the linear rail of each of the pair of end plates, wherein one end of each spring is coupled to the adjacent end plate at a third pivot, and an other end of each spring is attached to the carriage mounted to the adjacent end plate.

12. The spine module of claim 9, further comprising:
a spine controller including a processor in communication with each locking mechanism and configured to generate a locking command signal that causes each locking mechanism to adopt the locked state upon receipt and an unlocking command signal that causes each locking mechanism to adopt the unlocked state upon receipt.

13. The spine module of claim 12, wherein each linear rail extends approximately perpendicular to the longitudinal direction.

14. The spine module of claim 12, wherein each locking mechanism comprises a solenoid-servo system.

15. The spine module of claim 14, wherein the solenoid-servo system comprises:
a solenoid including a pin;
a servo in mechanical communication with the pin;
wherein the pin is configured to move linearly between an extended position and a retracted position to place the locking mechanism in the locked state and unlocked state, respectively; and
a lock panel positioned adjacent to the pin and including a plurality of holes arranged in a line that are dimensioned to receive the pin;
wherein receipt of a locking command signal from the controller causes the solenoid to activate and extend the pin into the locked position such that the pin is received within an opposing hole of the lock panel; and
wherein receipt of an unlocking command signal from the controller causes the solenoid to deactivate and causes the servo to activate, thereby retracting the pin into the unlocked position such that the pin is removed from an opposing hole of the lock panel.

16. A robot assembly comprising a spine module of claim 1.

17. The robot assembly of claim 16, further comprising:
a pair of half bodies coupled to opposing sides of the spine module in a movement direction;
a first half body including a first pair of legs and a first half body trunk;
a second half body including a second pair of legs and a second half body trunk;
wherein each of the first and second pair of legs are configured to move with two degrees of freedom; and
wherein opposing longitudinal ends of the spine module are coupled to respective ones of the first half body and the second half body.

18. A robot assembly comprising a spine module of claim 9.

19. The robot assembly of claim 18, further comprising:
a pair of half bodies coupled to opposing sides of the spine module in a movement direction;
a first half body including a first pair of legs and a first half body trunk;
a second half body including a second pair of legs and a second half body trunk;
wherein each of the first and second pair of legs are configured to move with two degrees of freedom; and
wherein opposing longitudinal ends of the spine module are coupled to respective ones of the first half body and the second half body.
